(19) United States
(12) Patent Application Publication
(10) Pub. No.: US 2004/0230866 A1
(43) Pub. Date: Nov. 18, 2004

(54) Test system for testing components of an open architecture modular computing system

(75) Inventors: Kirk Yates, Loomis, CA (US); Kirk Bresniker, Roseville, CA (US); Thane Larson, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX

(21) Appl. No.: 10/427,523

(22) Filed: Apr. 30, 2003

(51) Int. Cl. H02H 3/05

(52) U.S. Cl. 714/25

(57) ABSTRACT

A test assembly comprises a backplane interface to a backplane having at least one channel that further comprises a bi-directional two wire bus, a display interface capable of coupling to a display, and a control element. The control element is coupled to the backplane interface and the display interface. The control element is capable of snooping the bi-directional two wire bus and converting data on the bi-directional two wire bus to a readable format for display via the display interface.

### BACKGROUND OF THE INVENTION

A bladed server is a system that accepts multiple pluggable functional servers with little or none of the inconvenience of other systems. At a minimum, a blade is a server element that is capable of automatic connection to power when plugged into a system enclosure. A fundamental characteristic of a bladed server is called “simple provisioning’, the capability to easily insert an additional server blade into the enclosure and have the blade automatically power up and be recognized by the local system management console.

Bladed servers are a dramatic and significant development in server consolidation. Usage of a shared enclosure or rack mounted module for power distribution and supply simplifies installation to accommodate many server form factors and densities. In addition, bladed servers consolidate cables between servers, reducing complexity and clutter. Also, bladed servers enable individual management of the servers including, for example, remote power management, individual opening and power-cycling of consoles, and environmental monitoring capability.

The versatility of a bladed system complicates testing. A large variety of possible blades are available, some with similar functionality, some with widely varying functionality. Blades can be designed and manufactured by multiple diverse organizations with a wide range of functionality, purpose, application, and fundamental characteristics, leading to a wide range of test requirements and specifications.

### SUMMARY

What is desired is a system that enables management of testing for a wide variety of blades in a system or server.

According to some embodiments, a test assembly comprises a backplane interface to a backplane having at least one channel that further comprises a bi-directional two wire bus, a display interface capable of coupling to a display, and a control element. The control element is coupled to the backplane interface and the display interface. The control element is capable of snooping the bi-directional two wire bus and converting data on the bi-directional two wire bus to a readable format for display via the display interface.

According to other embodiments, a test assembly comprises a printed circuit board with physical dimensions compliant with a standard for open architecture modular computing components, a backplane interface coupled to the printed circuit board and capable of interfacing to a backplane, at least one power converter, and a test controller. The at least one power converter is mounted on the printed circuit board and capable of converting power from a single source to a power levels utilized on the printed circuit board. The test controller is coupled to the printed circuit board and capable of programmably and flexibly testing communication and control signals on the backplane.

According to further embodiments, an article of manufacture comprises a controller usable medium having a computable readable program code embodied therein for testing components in an open architecture modular system that includes a backplane having at least one channel that further comprises a bi-directional two wire bus. The computable readable program code further comprises a computable readable program code capable of causing the controller to snoop the bi-directional two wire bus, and a computable readable program code capable of causing the controller to convert signals snooped from the bi-directional two wire bus to a readable format.

According to other embodiments, a storage element readable by a controller tangibly embodying a program of instructions executable by the controller performs method steps for testing components in an open architecture modular system that includes a backplane having at least one channel that further comprises a bi-directional two wire bus. The method steps comprise snooping the bi-directional two wire bus and converting signals snooped from the bi-directional two wire bus to a readable format.

### BRIEF DESCRIPTION OF THE DRAWINGS

Embodiments of the invention relating to both structure and method of operation, may best be understood by referring to the following description and accompanying drawings.

FIG. 1 is a schematic pictorial diagram showing an embodiment of a test assembly that can be used to test and/or integrate elements, sometimes called blades, in a system such as a bladed server.

FIGS. 2A, 2B, and 2C are multiple schematic diagrams respectively illustrating a board, a rear transition module (RTM), and a backplane according to a standard configuration.

FIG. 3 is a schematic pictorial diagram showing the form factor of a printed circuit board in accordance with the PICMG™ 3.0 specification.

FIGS. 4A and 4B are schematic pictorial diagrams respectively showing an example of a shelf level implementation and a frame level implementation with a plurality of shelves.

FIG. 5 shows contact assignments for a zonel backplane connector.

FIGS. 6A and 6B are a bit diagram and associated timing diagram respectively showing an example of data and timing signals for communicating signals on an I²C bus.

FIG. 7 is a schematic flow chart depicting an example of a programmed process or method that communicates data over the I²C bus.

FIG. 8 is a schematic block diagram illustrating an example of a management system, such as a server, that is capable of accepting elements or blades and can be tested using the described test assembly.

### DETAILED DESCRIPTION

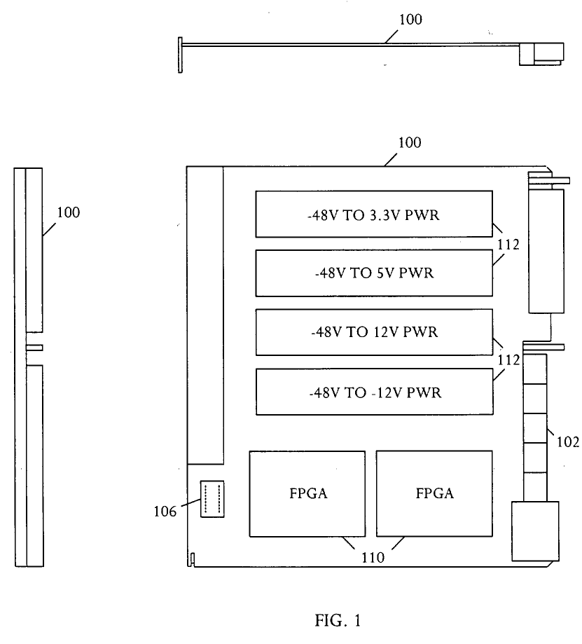

Referring to FIG. 1, a schematic pictorial diagram illustrates an embodiment of a test assembly 100 that can be used to test and/or integrate elements, sometimes called blades, in a system such as a bladed server. The system can integrate any type of element, for example storage components, processors, communication elements, and others. The illustrative test assembly 100 includes a backplane interface 102 capable of coupling to a backplane, a display interface 106 capable of coupling to a display, and at least one control element 110 that can be used as a test controller. The backplane has at least one channel that further comprises a bi-directional two wire bus such as an I²C bus. The control element 110 is capable of snooping the bi-directional two wire bus and converting data on the bi-directional two wire bus to a readable format for display via the display interface 106.

The test assembly 100 may have various forms such as a circuit board, printed circuit board, a portion of a printed circuit board or other circuit board, multiple circuit boards, an integrated circuit chip, and the like. In some embodiments, the test assembly 100 may include one or more power converters 112 mounted on the test assembly 100 and capable of converting power from a single source to a power levels utilized on the test assembly 100. In the illustrative example, the test assembly 100 has a plurality of separate individual power converters 112. The illustrative power converters 112 include a −48V to 3.3V, 50W converter, a −48V to 5V, 50W converter, a −48V to 12V, 50W converter, and a −48V to −12V, 36W converter. Other examples may include power converters 112 that converter other voltages and wattages.

The control element 110 may be implemented as various types of elements such as Field Programmable Gate Arrays (FPGA), controllers, processors, microprocessors, digital signal processors, state machines, volatile memories such as Random Access Memories (RAM), nonvolatile memories of various types, Read Only Memories (ROM), and others. The control element 110 generally includes a controller or processor in combination with a storage element capable of storing a set of codes or instructions that execute on the controller or processor. The storage element functions as a medium, and/or is programmed or loaded from a medium that determines functionality and operations of the control element 110. The storage element may be programmed or loaded with a computable readable program code made available via an appropriate media that embodies operations such as test functions. Various media may include disk or tape storage media, and media made available from remote locations via electronic or communication channels.

The test assembly 100 complies with various standards and specifications. In the illustrative example, the test assembly 100 meets specifications for open architecture modular system according to a Peripheral Component Interconnect (PCI) Industrial Computer Manufacturers Group (PICMG™) specification. For example, the test assembly 100 can be used to facilitate testing of a PICMG™ 3.0 system including testing and integration of individual 3.0 blades and/or entire systems. In a particular application, the test assembly 100 can same time and thus cost by enabling standardization and expediting of tests within PICMG™ systems.

PCI Industrial Computer Manufacturers Group (PICMG™) 3.0 specification defines a standard for open architecture modular computing components that can be easily and quickly integrated to support a variety of network elements, processors, storage devices, and input/output elements. PICMG™ supports and integrates multiple wireless, wireline, and optical network elements and supports many types and varieties of processors, digital signal processors (DSPs), storage, and I/O systems. PICMG™ supports high levels of modularity, configurability, scalability, and availability.

Mechanical packaging for PICMG™3.0 systems addresses functional needs of central office and data center environments. Basic PICMG™ elements include a backplane, boards that plug into a front section of the backplane, transition modules that plug into a rear section of the backplane, and a rackmount shelf. Features of the PICMG™ specification include a board size sufficient for a high level of integration and functionality, enough front panel space for I/O connectors and mezzanines, clearance for tall components, and support for high power and cooling levels.

A PICMG™ 3.0 to 3.0 test assembly 100 enables I²C bus snooping by allowing the display, for example a Liquid Crystal Display (LCD) to be connected to the I²C bus through control elements 110. The control elements 110 convert data from the I²C bus format to a readable format enabling a person performing tests and analysis to better evaluate communication on the I²C bus. The PICMG™ 3.0 to 3.0 test assembly 100 can enable stressing and testing of every signal passing across the backplane. The display shows graphics to confirm test results.

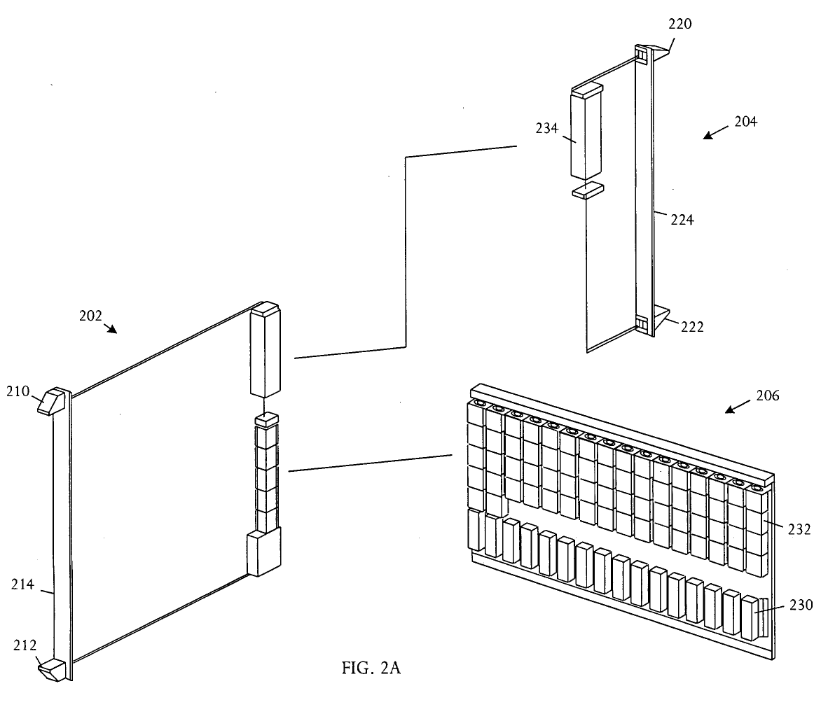

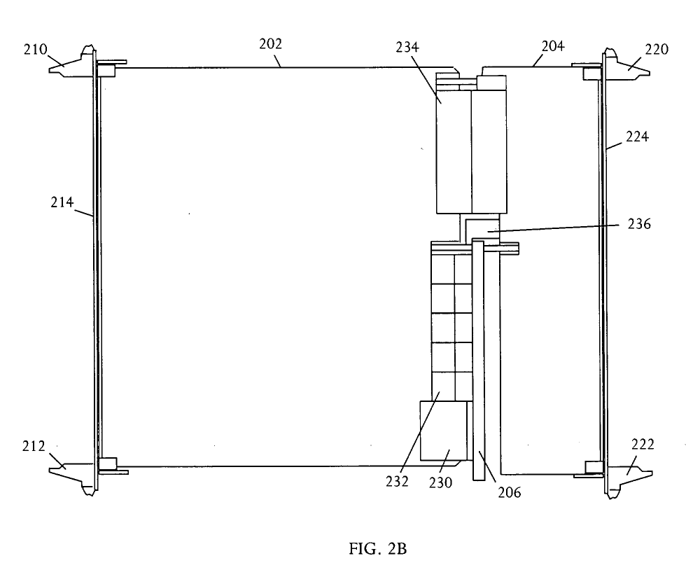

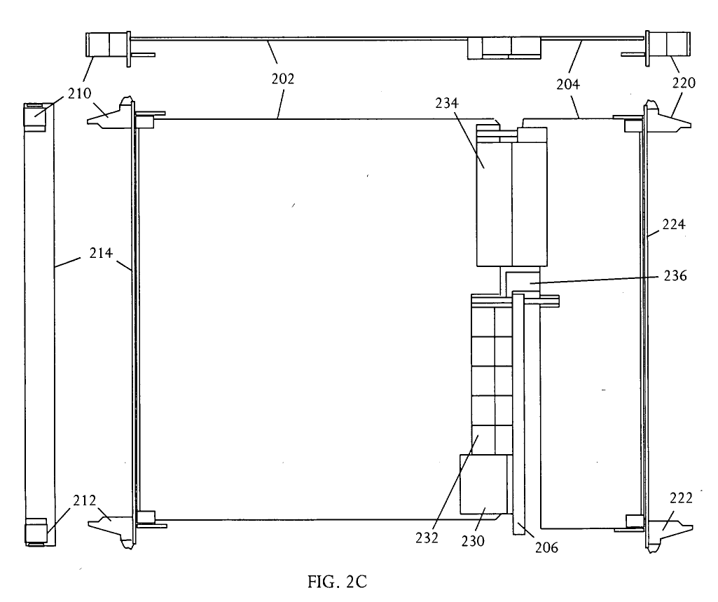

Referring to FIGS. 2A, 2B, and 2C, multiple schematic diagrams respectively illustrate a board 202, a rear transition module (RTM) 204, and a backplane 206 according to a standard configuration, specifically the PICMG™ 3.0 standard configuration. In an illustrative embodiment, the test assembly 100 complies with PICMG™ 3.0 form factor, height, width, thickness, and connector and signal layout and placement to enable testing of the particular standard. Other test assemblies can be configured for other standards.

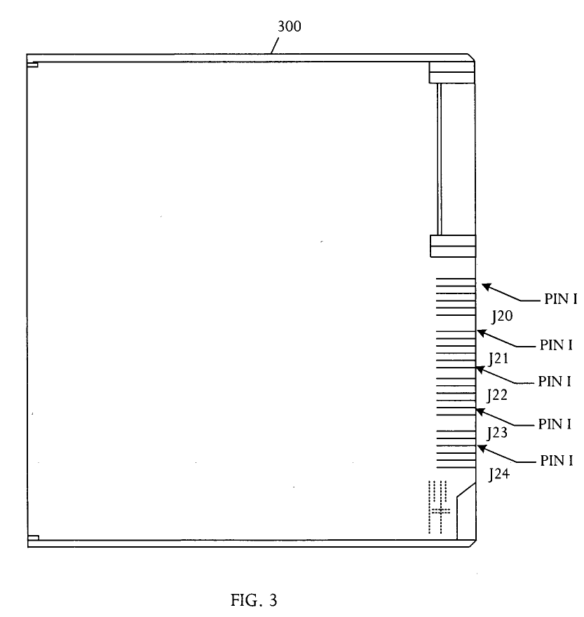

FIG. 2A is a perspective pictorial diagram showing connections of the board 202 with both a RTM printed circuit board configuration 204, and a 16-slot backplane example 206. FIG. 2B is a pictorial side view showing the arrangement of the board 202, backplane 206, and RTM 204. The front board 202 has top 210 and bottom 212 handles, and a front panel 214. The RTM 204 has top 220 and bottom 222 handles and an RTM panel 224. Connectors are separated into three zones, a power and management zone 1 230, a data transport zone 2 232, and a rear I/O zone 3 234. Also shown is a backplane support bar 236. FIG. 2C shows correspondence of top and front views to the side view. FIG. 3 is a schematic pictorial diagram showing the form factor of a printed circuit board 300 in accordance with the PICMG™ 3.0 specification.

PICMG™ specifies connectors in three zones. Zone 1 230 includes DC power, ring/test voltages, and shelf management system connections including hardware addresses using dual redundant minus 48V DC power. Zone 2 232 supports up to five Zd connectors per board to cover data fabric such as base fabric and extended fabric, update channels, and bused timing clocks. Zone 3 234 defines rear panel I/O connectors.

Zone 1 230 connectors are defined as the interface between subracks and boards for dual redundant −48V DC power, metallic test, ringing generator, shelf management system connections, and hardware addressing. The zone 1 230 connector has eight power contacts and 26 low current contacts. A single connector is capable of supplying power to single-wide or double-wide slots/boards. The −48V DC power circuit definition is used generically or nominally and refers to the DC voltage level supplied, which can range from −36V DC to −72V DC.

The ring 1 metallic test circuits enable access to a shared pair of common shared test buses in the backplane. A card may function as a metallic test head, a line termination unit, or both. The backplane may also route the signals to connectors that permit connection of external test heads or creation of daisy-chain multiple shelves. Usage of two pairs supports testing of 4-wire circuits such as T1 s, or supports test heads of different types simultaneously on the same shelf.

Referring again to FIG. 2B, within a zone 2 (232) connector each row or wafer contains four differential signaling pairs with each pair having an individual L-shaped ground contact. The ground contact is connected to a logic ground on a board with backplane ground contacts interconnected and connected to logical ground.

Zone 3 234 has three interconnect types including: (1) an interconnect mating a board directly to a rear transition module (RTM) with no intermediate backplane interconnection, (2) a connection with no rear-side connection to the shelf, (3) a connection using a cable bulkhead using metal brackets that mount above the backplane to supply direct cable connections to boards through zone 3 234, and (4) a connection using an auxiliary backplane region that may extend the backplane from zone 1/zone 2, or may be a separate zone 3 234 backplane.

The rear transition modules (RTMs) are optional modules that facilitate board servicing by moving I/O cable assemblies from the board to the RTM. I/O signals from the board are routed to zone 3 234 where a user-defined connector mates with the RTM and passes signals outside the rear of the shelf, enabling servicing of boards without disconnecting and reconnecting multiple cable assemblies.

Referring again to FIG. 1, in some PICMG™ 3.0 applications the test assembly 100 can support functionality and availability to all communication and control signals across the backplane 206. Other applications may limit the communication and control signals that can be accessed. For example, the test assembly 100 includes multiple control elements 110 such as FPGAs with particular control elements 110 configured for specific signals via a PICMG™ 3.0 backplane connector. Multiple FPGAs enable flexible design via a capability to download different test functions for testing different 3.0 blades without modifying test assembly hardware.

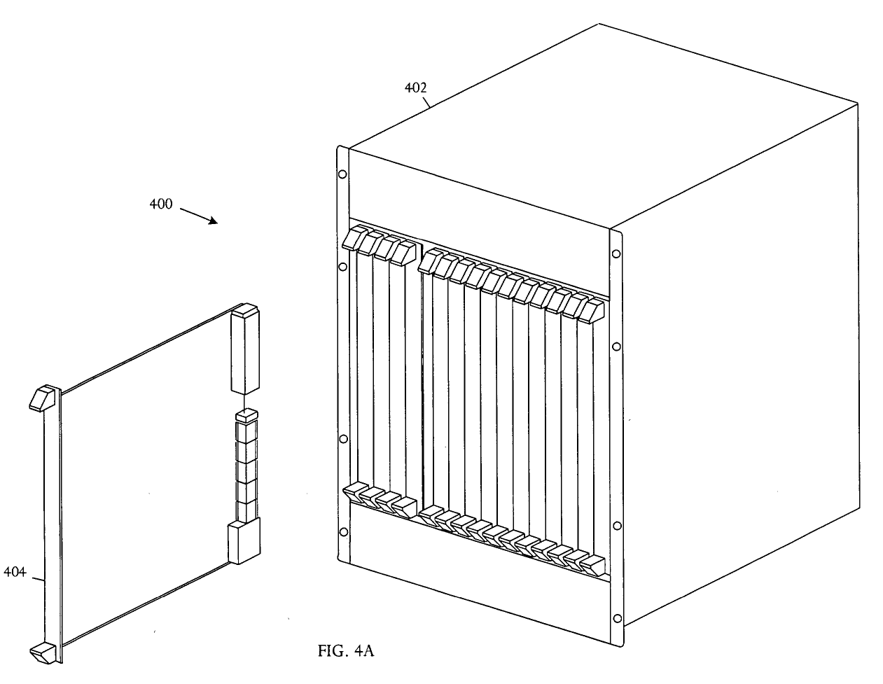

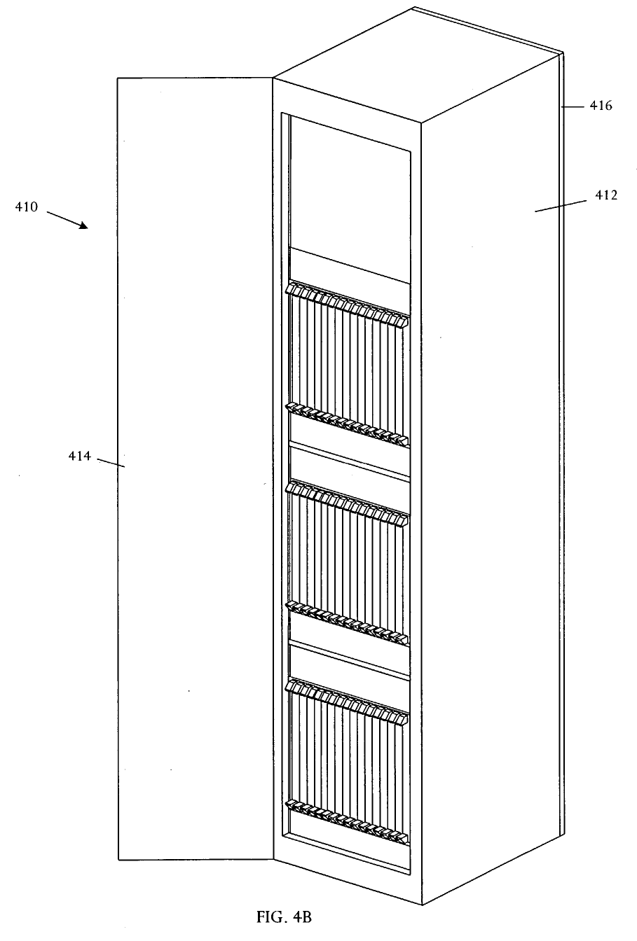

Referring to FIGS. 4A and 4B, schematic pictorial diagrams respectively show an example of a shelf level implementation 400 and a frame level implementation 410 with a plurality of shelves 400. The shelf 400 includes a card cage 402 or housing that can accept a plurality of boards 404 or card assemblies. The frame 410 includes a cabinet 412 that holds shelves 400 on a plurality of levels. The cabinet 412 has a front door 414 and rear door 416 for accessing cards, boards, and shelves 400. The illustrative frame 410 houses up to three shelves 400 in addition to a level that holds PDU.

At the board, shelf 400, and frame 410 level, the system is designed to attain high density footprint-efficient packaging and facilitate servicing from front and rear. The system also is configured to supply sufficient cabling space, airflow, power entry.

PICMG™ 3.0 specification specifies dual, redundant −48V DC supplied to each frame 410 from one or two power plants within a facility. In some facilities, a signal conditioning panel filters the power lines to reduce radiated and conducted noise, feed cable inductor compensation, overcurrent protection, and voltage ripple. Primary feeds are divided into multiple branches although remaining mutually isolated. PICMG™ 3.0 shelves supply the dual DC feeds to all front plug-in boards through a zone 1 connector mounted on the backplane.

All power is supplied on the dual, redundant −48V DC feeds in PICMG™ 3.0 systems. Logic voltages are generated on each board, if needed, and are implemented using isolated power supplies, normally DC-DC converters, that reside on the individual boards. DC isolation prevents a low impedance path between the −48V DC feeds and board circuitry. Frame level power distribution includes power filtering and circuit protection within the distribution panel.

In the test assembly 100 depicted in FIG. 1, the power converters 112 access the −48V DC power feeds from the backplane 206 and convert to power levels that are usable by components on the circuit boards, for example the 3.3V, 5V, ±12V levels. The power converters 112 include appropriate DC-DC converters, filters, and circuit protection elements for power conversion.

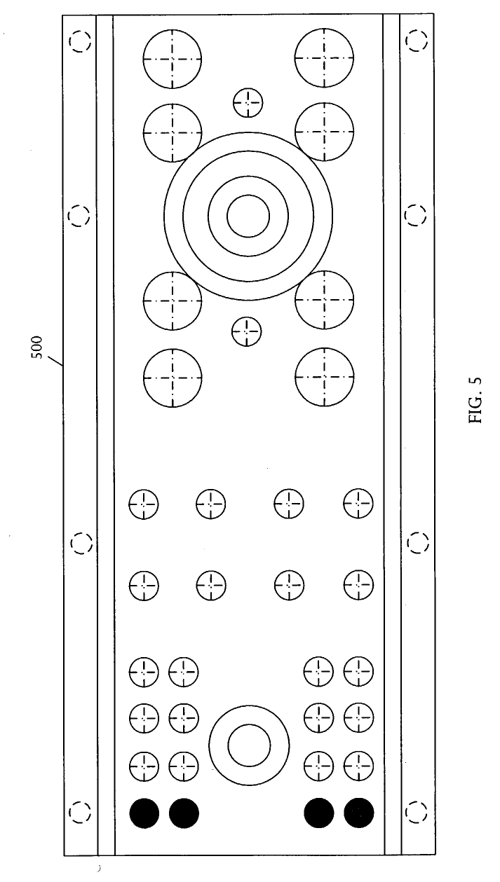

Referring to TABLE I in combination with FIG. 5, TABLE I shows contact assignments for a zone 1 backplane connector 500. The individual blades have unique signals that can be monitored and toggled to implement testing. The test assembly 100 shown in FIG. 1 is configured with programming and programmable flexibility for usage with any blade. The control elements 110 can be reprogrammed according to the particular signaling characteristics of a blade.

TABLE I

| | | Mating Sequence |
|---|---|---|
| Designation | Contact Number | Upon Insertion |
| Reserved | 1 | N/A |
| Reserved | 2 | N/A |
| Reserved | 3 | N/A |
| Reserved | 4 | N/A |
| HA0 Hardware Address Bit 0 | 5 | Fourth |
| HA1 Hardware Address Bit 1 | 6 | Fourth |
| HA2 Hardware Address Bit 2 | 7 | Fourth |
| HA3 Hardware Address Bit 3 | 8 | Fourth |
| HA4 Hardware Address Bit 4 | 9 | Fourth |
| HA5 Hardware Address Bit 5 | 10 | Fourth |
| HA6 Hardware Address Bit 6 | 11 | Fourth |
| HA7/P Hardware Address Bit | 12 | Fourth |
| 7 (Odd parity bit) | | |
| SCL A IPMB Clock, Port A | 13 | Fourth |
| SDA A IPMB Data, Port A | 14 | Fourth |
| SCL B IPMB Clock, Port B | 15 | Fourth |
| SDA B IPMB Data, Port B | 16 | Fourth |
| MT1_TIP | 17 | Fourth |
| MT2_TIP | 18 | Fourth |
| RG1_TIP | 19 | Fourth |
| RG2_TIP | 20 | Fourth |
| MT1_RING | 21 | Fourth |
| MT2_RING | 22 | Fourth |
| RG1_RING | 23 | Fourth |
| RG2_RING | 24 | Fourth |
| SHELF_GND | 25 | First |
| LOGIC_GND | 26 | First |
| ENABLE_B | 27 | Fifth |
| VRTN_A | 28 | First |
| VRTN_B | 29 | First |
| −48V_EARLY_A | 30 | First |
| −48V_EARLY_B | 31 | First |
| ENABLE_A | 32 | Fifth |
| −48V_A | 33 | Second |
| −48V_B | 34 | Third |

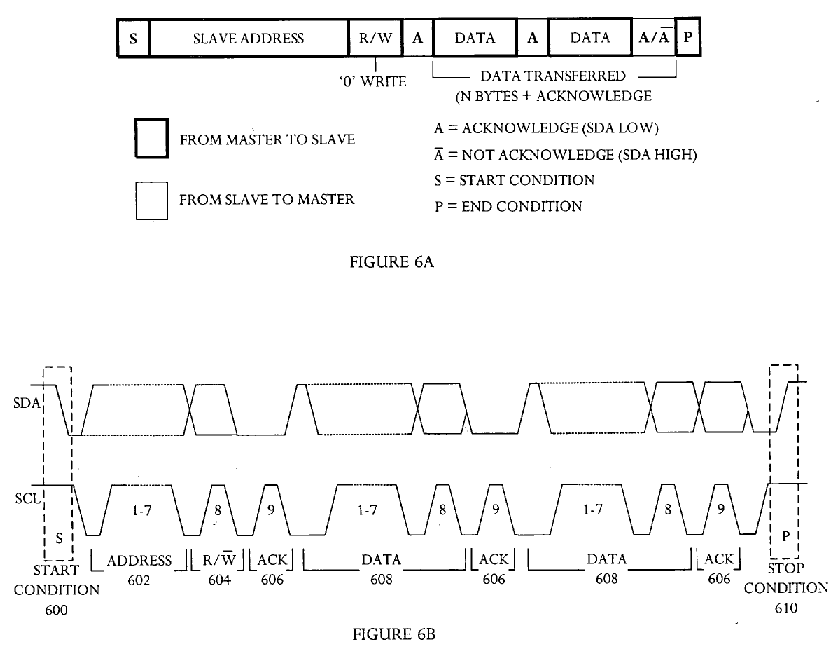

Referring to FIGS. 6A and 6B, a bit diagram and associated timing diagram respectively show an example of data and timing signals for communicating signals on an I²C bus. The timing diagram shows timing of signals on the serial data line (SDA) and serial clock line (SCL) in a complete data transfer. The I²C bus is a simple bi-directional two wire bus for efficient inter-integrated circuit control. I²C bus compatible devices incorporate an on-chip interface that enables direct intercommunication among devices coupled to the I²C bus. The two bus lines for the I²C bus, a serial data line (SDA) and a serial clock line (SCL), are bidirectional lines that carry information between devices connected to the bus. Each device connected to the I²C bus is software addressable by a unique address with simple master/slave relationships defined at all times. Master devices operate as either master-transmitters or master-receivers. A master is the device that initiates a transfer on the bus and generates clock signals permitting the transfer. In response, any device addressed is considered a slave.

The I²C bus is a multiple master bus that includes collision detection and arbitration to prevent data corruption for simultaneous data transfers by more than one master. Data transfers are serial 8-bit oriented and bi-directional at a rate up to 100 kbit/s in standard mode, 400 kbit/s in fast mode, or 3.4 Mbit/s in high-speed mode.

According to the I²C bus specification data on the SDA line must be stable during the HIGH clock period. The HIGH or LOW state of the data line can only change when the clock signal on the SCL line is LOW.

In some embodiments, the system can include interfacing hardware that detects the START and STOP conditions. In other embodiments, the system can sample the SDA line at least twice per clock period to sense the START or STOP transition.

A master generates START and STOP conditions. The I²C bus is considered busy after the START condition and considered to be free a specified time after the STOP condition. The bus remains busy is a repeated START (Sr) is generated rather than a STOP condition. A START (S) condition is a HIGH to LOW transition on the SDA line while SCL is HIGH. A STOP (P) condition is a LOW to HIGH transition on the SDA line while SCL is HIGH.

Every data byte transferred on the SDA line is 8-bits long with the possible number of bytes unrestricted. Each byte is followed by an acknowledge bit. Data transfers in the order of most significant bit (MSB) first. A slave that cannot receive or transmit a complete data byte until another operation is complete can hold the SCL clock line low to force the master into a wait state with the transfer continuing when the slave is ready.

The master generates an acknowledge-related clock pulse. The transmitter releases the SDA line (HIGH) during the acknowledge clock pulse. The receiver pulls down the SDA line during the acknowledge pulse so that the line remains stable LOW during the HIGH period of the clock pulse. A slave that fails to acknowledge the slave address, for example if busy, leaves the data line high. The master can respond by generating a STOP condition to abort the transfer or a repeated START condition to begin a new transfer. A slave-receiver that acknowledges the slave address and begins a transfer but later cannot continue the transfer can generate a not-acknowledge. The slave leaves the data line HIGH and the master generates either a STOP or repeated START condition. A master-receiver involved in a transfer signals the end of data to the slave-transmitter by not generating an acknowledge on the last byte that was clocked out of the slave.

In the example, a master-transmitter addresses a slave-receiver with a 7-bit address and no change in transfer direction. The master transmits a start bit (S) 600 to the slave to begin the communication, sends the slave address 602, and sends a bit indicative of a data write 604. The slave responds with an acknowledge bit 606 and the master sends the data 608. Between transfers of data 608, the slave sends acknowledge bits 606, an SDA low signal, for N bytes and a final acknowledge/not acknowledge, SDA low signal followed by SDA high signal, after the last data byte. The master terminates the transmission with a stop condition (P) bit 610.

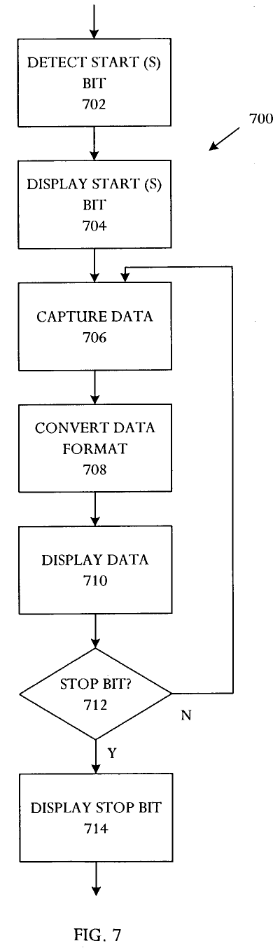

Referring to FIG. 7, a schematic flow chart depicts an example of a programmed process or method that communicates data 700 over the I²C bus. A processor is programmed to recognize a start bit (S) by monitoring the serial data line (SDA) and determining when the SDA signal goes low and no activity is present on the serial clock line (SCL).

The system can determine whether activity is present on the SCL line by monitoring for a time duration (t>1) determined by the bit rate. For example if the bit rate is 100 k, then if SCL does not change for 10 μsec, no activity is present. A stop bit (S) occurs after acknowledge (ACK) or a ninth SCL signal. A stop bit (P) is defined as simultaneous 1 levels on SCL and SDA.

A transfer begins with start bit (S) detection 702 and the system responds by sending a signal indicative of the start bit (S) to a monitor for display 704. The system then captures data bits 706, for example eight bits, and converts the data to a format appropriate for display 708, in one example a hexadecimal display format. The system sends data in the displayable format to the monitor for display 710 and captures an acknowledge bit (0) or not acknowledge bit (1). If the next bit is a stop bit (P) 712, the system sends a signal indicative of communication completion, for example a P code, to the display 714. Otherwise, the system captures a next data bit by looping back to the capture data bit action 706.

In one example, the monitor displays communication data in the form:

S XX A XX A XX AP

where S indicates the start bit, P the stop bit, A the acknowledge, and XX hexadecimal data. Other examples may display data in other forms including graphic or image form.

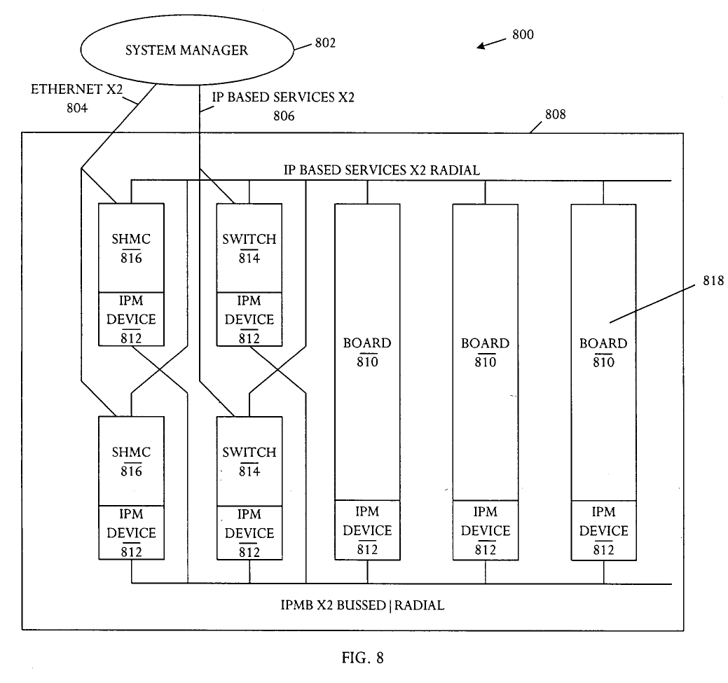

Referring to FIG. 8, a schematic block diagram illustrates an example of a management system 800, such as a server, that is capable of accepting elements or blades and can be tested using the described test assembly. The illustrative management system 800 can be a PICMG™ 3.0 System. The management system 800 includes a system manager 802 that communicates via Ethernet 804 and Internet Protocol (IP) Based Services 806 with a shelf 808. The shelf 808 contains a plurality of components and boards 810 that can be inserted and removed from the management system 800. The individual elements and boards 810 each have an associated Intelligent Peripheral Management (IPM) device 812. The elements include switches 814 and shelf management controllers (ShMC) 816.

A test assembly 818 can be inserted as one of the boards 810 to enable testing of any other boards 810, the management system 800, and various interactions among elements and boards of the management system 800. The test assembly 818 can be used to test a wide range of signals. In some embodiments, the test assembly 818 can test signals such as address signals, clock signals, data signals, tip signals, ring signals, ground signals, enable signals, and power rails.

A zone 1 shelf management controller 816 has extensive multiple-level management capabilities that may be used by an overall system manager including low-level hardware management services, high-speed management services based on the TCP/IP protocol suite, and in-band application management. Shelf management 816 monitors, controls, and assures proper operation of boards 810 and other shelf components. Shelf management 816 monitors basic system health, reports anomalies, and responds by initiating corrective actions. The shelf management system can retrieve inventory information and sensor readings, receive event reports and failure notifications from boards and other units, and can perform basic recovery operations such as power cycling or entity reset. The test assembly 818 can monitor traffic to and from the shelf management controller 816 to enable collection and conversion of bus data into a format that can be displayed.

Low-level hardware management services of the shelf management system include control of power, cooling, and interconnect resources. A management entity on individual boards negotiates power usage and cooling needs, and allocates resources, before powering the board. The shelf management system has multiple components including distributed management processors to manage and monitor operation and health, an intelligent peripheral management interface (IPMI) 812 that supplies communications, management, and control among distributed managers, and a higher-level, high-speed service for boards using TCP/IP management services such as remote booting, SNMP management, remote disk services, and other IP-related services.

The Intelligent Peripheral Management (IPM) controller components 812 are powered from the main shelf redundant −48V power buses and are thus operational before any other component, facilitating management of and controlling power to the other components.

Communications and control for the Intelligent Platform Management (IPM) controllers 812 are supplied by an Intelligent Platform Management Interface (IPMI) protocol that defines a baseboard management controller (BMC) that monitors managed devices, reports anomalous conditions, and initiates corrective action. The IPMI monitors hot-swap events from removable devices, indicating entry and detecting shutdown or removal.

Communication and control signals that communicate across the backplane include IPMI command and Field Replaceable Unit (FRU) records. IPMI command definition conventions conform to a specified multiple-byte format. A first byte specifies a Responder Slave Address of a device that is expected to respond to a message. A second byte specifies the network function of the message and logical unit number (LUN) of the unit meant to respond to the message (NetFn/Responder LUN). Third and fourth bytes are a header checksum and request slave address, respectively. A fifth byte is a Request Sequence identifier used to determine whether duplicate requests or responses have been received and a Requester LUN identifying the LUN that should receive the response. A sixth byte identifies the command within NetFN that is to be executed. Bytes 7-N include zero or more, up to 24, command specific data bytes. A final byte is a data checksum of the message back to, but not including, the header checksum.

Every command has a corresponding response in a format that includes a first byte indicative of a request slave address of the requesting device indicative of the device that receives the response. A second byte specifies the network function of the message and logical unit number (LUN) of the unit meant to receive the response (NetFn/Responder LUN). Third and fourth bytes are a header checksum and responder slave address, respectively. A fifth byte is a Request Sequence identifier used to determine whether duplicate requests or responses have been received and a Responder LUN identifying the LUN that sent the response. A sixth byte identifies the command within NetFN that was requested. Byte 7 is a completion code that defines whether the command successfully executed. Bytes 8-N are zero or more, up to 23, command specific response data bytes. A final byte is a data checksum of the message back to, but not including, the header checksum.

The IPM controller 812 implements multiple addressing schemes including four types of addresses, hardware addresses, IPM bus address, physical address, and shelf address. The hardware address is assigned through hardware signals from the backplane or shelf to a module. An IPM controller 812 in the shelf is assigned a hardware address that is “hardwired” on the backplane or elsewhere in the shelf. The test assembly 818 monitors the addresses as well and data and other information.

The IPM address is used by the IPM controller 812 when sending or receiving information on the IPM bus (IPMB). The IPMB infrastructure is layered above the I²C protocol and supports 7 bit addresses. The hardware address and IPMB address both support 7 bit addressing so that the hardware address can be used without translation as the I²C/IPMB address. Some hardware and IPMB addresses are reserved, including a general call address, and a temporary address for error reporting. The test assembly 812 snoops the I²C bus to monitor the various types of information for display and analysis.

Physical address describes the physical location of a Field Replaceable Unit (FRU) in the shelf and is used for directing, an operator to take an action on the physical FRU. To reduce the bus traffic for an IPM controller to determine addresses, the shelf manager implements a “Get Address Info” command for requested data and response data. For request data, the command uses multiple bytes in a data field including a PICMG™ identifier showing a defined group extension, a FRU device identifier, and an address key type. The request data also includes an address key and a site type for a physical address. The response data includes fields for a completion code, PICMG™ identifier, hardware address, IPMB-0 address, FRU device identifier, site identifier, and site type.

The shelf manager accepts four address types for a lookup value to allow an IPM controller 812 to look up information from another device in the system. The IPM controller 812 controller may implement additional FRUs that do not appear in the address table record. Therefore, a “Get PICMG Properties” command enables querying for the maximum FRU device identifier supported by the IPM controller. Request data for the Get PICMG Properties command includes a PICMG identifier. Response data includes a completion code, the PICMG identifier, a PICMG extension version indicative of extensions implemented by the IPM controller, a maximum FRU device ID, and the FRU device ID for the IPM controller 812.

The “Get Address Info” command can be used by the shelf manager 816 to look up the hardware address in the table using the FRU device ID as an offset. In another example, the shelf manager 816 can use the command to computer the corresponding hardware address from the IPMB.

In addition to addressing individual locations within a shelf 808, the location of a shelf can also be addressed. A “Get Shelf Address Information” command determines shelf address using a single byte of request data, the PICMG identifier. Response data of the command includes a completion code, the PICMG identifier, a shelf address type/length byte identifier, and shelf address bytes for the shelf containing the IPM controller 812.

A “Set Shelf Address Information” command can be implemented by the shelf manager 816 to enable configuration of the shelf address. The “Set Shelf Address Information” command uses a single byte of request data, the PICMG identifier. Response data of the command includes a completion code, the PICMG identifier, a shelf address type/length byte identifier, and shelf address bytes for the shelf containing the IPM controller 812.

The PICMG™ system supports components at the Field Replaceable Unit (FRU) level including mezzanine devices, intelligent fans, non-intelligent removable fans that are managed by other IPM controllers 812 and the like.

IMP controllers generally use multiple sensor devices and maintain a Sensor Device Record (SDR) for each sensor represented by the IPM controller 812. The sensors can be associated with a FRU or can be subordinate to and managed by an IPM. Sensors arc capable of issuing events during some state changes. The IPM controller SDR contains a Management Controller Device Record that retrieves information about the IPM controller, associated capabilities, and a FRU device locator record for the individual managed FRUs.

Sensor Data Records (SDRs) describe sensors and other elements in shelf management systems including FRU records, management device locations, object groupings, and others. The FRU record indicates existence and accessibility of FRU devices. The test assembly 812 can be used to track SDR data.

A hot swap sensor is implemented by each IPM controller 812 and monitors insertion and extraction of a FRU. FRU state can be monitored by querying the hot swap sensor. A FRU hot swap event message indicates a state transition associated with a FRU and specifies multiple request data bytes including an event message code, a sensor type, a sensor number, an event direction indication, and event type, and event data indicative of FRU status such as not installed, inactive, insertion pending, activation in process, active, and extraction pending. Other event data includes event cause such as user deactivation request, change commanded, autonomous state change, surprise extraction state change, and state change from unknown cause. Other data includes a FRU device identifier and a completion code. The test assembly 812 can be used to access and display hot swap signals.

Other signals that pass across the backplane include device commands that supply control over operational state of the FRUs and FRU LEDs, including FRU reset commands and control over IPMB buses. SetFRUReset is used to force a reset of the payload site of a FRU device so assert and hold, or deassert the reset line, or issue a momentary reset. A SetFRUActivationPolicy command modifies operational state transition behavior of a FRU device. GetFRUActivationPolicy command reads the activation policy. SetFRUActivation command controls the operational state transition of a FRU including activation and deactivation. The test assembly 812 can monitor and display signals indicative of FRU operational state. SetFRULEDState command enables manual manipulation of FRU LED behavior. GetFRULEDState returns LED state managed by the IPM controller 812 on the FRU.

The shelf manager 816 manages and tracks FRU population and common infrastructure of a shelf, particularly power, cooling, and interconnect infrastructure. The shelf manager 816 also enables the system manager 802 to cooperate in management and tracking through a System Manager Interface. The test assembly 812 can be used to monitor and display the power, cooling, and interconnect signals for testing and analysis.

IPM controllers 812 and associated sensors are considered to be “dynamic sensor devices” that are discovered by responding to a “Broadcast Get Device ID” message. A “Get Device Locator Record ID” command requests data using a PICMG identifier and FRU device ID. The corresponding response data includes a completion code, the PICMG identifier, and the record ID for the appropriate device locator SDR.

A Field Replaceable Unit (FRU) is a unit that can be replaced by a customer in the field. FRU information relates to information stored within the FRU in a non-volatile storage location. FRU information access commands are read or write IPMI commands directed to the IPM controller that hosts the FRU information. Various types of FRU information may be accessed. For example, shelf FRU information is held in an IPM controller that provides access to the shelf FRU information. Shelf FRU information includes a Board Information Area, a Chassis Information Area, and a Multirecord Area. Shelf FRU devices can be located using interrogation commands including a “Get Address Info” command to find the IPM controller that hosts the information and a “Read FRU Data” command to determine whether the requested data is stored. The test assembly 812 can be used in various applications to access FRU information and commands to determine various board and shelf information.

The PICMG™ system supports Electronic Keying (e-keying) that utilizes FRU information represented by the various IPM controllers in the shelf to generate Enable/Disable commands according to a sequence of events. First a module is inserted into an operational shelf or power is applied to a shelf. After shelf power-on, the shelf manager is selected and determines backplane characteristics from the shelf FRU information. The module IPM device activates and payload backplane connections remain disabled. Module IPM FRU information is read by the shelf manager 816 to determine channel capabilities for base interface, fabric interface, telephony clocking, update channel interface, and metallic test bus and ring generator bus. The shelf manager issues Enable/Disable Port commands as the channels or ports become available. The test assembly 812 is capable of accessing and monitoring channel information for purposes including testing.

A shelf 808 can use the Intelligent Peripheral Management Bus (IPMB) for system management communications between all intelligent FRUs. Reliability can be improved by using multiple redundant IPMBs operating in an active-active mode so that both IPMBs carry IMPI traffic simultaneously to effectively double available bandwidth. The PICMG™ backplane includes multiple IPMB channels. In various embodiments, the IPMB management buses can be implemented as standard multiple-drop I²C buses or other bus configurations such as a star configuration.

IPMB bus control commands are used to enable or disable operational state of IPMB buses for an IPM controller. IPMB physical link sensors are implemented on IPM controllers and are used to monitor the state of the IPMB management interfaces. Interface state can be queried using an IPMI SetSensorReading command with events sent to signify link failure or recovery. A SetIPMBState command enables management software to set IPMB physical link state.

The test assembly 812 can also monitor shelf manager control of power and cooling. During a discovery stage, the shelf manager 816 collects data from the shelf and from boards 810 and other FRUs regarding power capabilities and requirements. The shelf manager 816 enables boards and FRUs to power up based on capabilities of the shelf 808, in some instances allocating power levels at a lower level than requested.

During normal operations the shelf manager 816 waits for event messages from boards 810 and/or FRUs to adjust cooling or power distribution from current operating conditions. No information descriptor or commands are used for the normal operations state. An abnormal operation state occurs when a board or FRU generates an event message requesting shelf services from the shelf manager. The shelf manager responds, for example by adjusting system cooling or power to return the module to the normal operation state. The abnormal operation state begins when a board or FRU generates an event message requesting shelf services from the shelf manager. Typically, the shelf manager will adjust system cooling or power to one or more modules to attempt to return to the normal state.

The boards 810 and FRUs inform the shelf manager 816 of the average statistical maximum power draw when powered off and on. For example, the shelf manager queries the individual FRU/IPM device using a ComputePowerProperties command. A FRU responds to the command with the number of spanned slots, IPM location, and management power draw. The shelf manager queries each FRU/IPM device using a GetPowerLevel command. The FRU responds with variable such as steady state power draw levels, desired steady state power draw level, early power draw level, and desired early draw power level. The shelf manager 816 informs the FRU/IPM device of the appropriate allocated power level using a SetPowerLevel command that is either the desired power level or an alternative specific power level. The FRU responds to acknowledge the power level setting.

Power negotiations can occur when a shelf 808 first receives power, when a board or FRU is hot-swapped, or when a board or FRU determines a change is appropriate. Power negotiation is divided into four different messages. The first command of the power negotiation sequence is a ComputePowerProperties command that is sent by the shelf 808 manager to the IPM controller 812 to inform the device to lock desired power and cooling levels. The IPM controller 812 returns part of the data in response to the command including the number of spanned slots, the IPM controller location, and management power draw. The IPM controller also responds to the ComputePowerProperties command by preparing for receipt of a GetPowerLevel command, specifically by caching desired power levels. The shelf manager uses the information to determine the desired power level of the FRU and corresponding levels of power draw. The shelf manager sends a SetPowerLevel command if the power budget allows the FRU to change power level. The command can enable or disable the payload.

When a FRU desires to change power level, the IPM controller 812 sends a RenegotiatePower command to the shelf manager for the FRU or all FRUs under the IPM controller 812. A RenegotiatePower command designates which FRU desires to have power levels renegotiated. The command informs the shelf manager 816 to begin a, negotiation with the FRU(s). At the end of the renegotiation, the shelf manager sends a SetPowerLevel command to the IPM controller to convey the conclusion.

Power renegotiation begins when a FRU or board requests a new power level using a RenegotiatePowerLevels command. The shelf manager acknowledges the FRU/board request and queries each FRU/IPM device using a ComputePowerProperties command. FRU responds to the command with the number of spanned slots, the IPM location, and management power draw. The get or set power level transaction then takes place.

The test assembly 812 can be used to access and monitor the various aspects of power negotiation and renegotiation.

Other commands include GetFanSpeedProperties and GetFanLevel commands for cooling management operations. The test assembly 812 can monitor various fan information and diagnostics.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, the disclosed system or server is described as compliant with the PICMG™ 3.0 specification. Other examples may be compliant with other standards, partially compliant with a standard, compliant with parts or all of multiple standards, or may be compliant with no standards. Similarly, the description specifically describes particular signals that can be monitored and tested using the test assembly. Some embodiments may be capable of testing different signals or may not implement testing of the particular signals, phenomena, and conditions described herein. The disclosed system is described as performing the access and monitoring functions via the I²C bus. In other embodiments, other buses may be accessed or monitored. In some embodiments, the signals may be accessed from lines or test points that are not buses.

What is claimed is:

1. A test assembly comprising:
a backplane interface to a backplane having at least one channel that further comprises a bi-directional two wire bus;
a display interface capable of coupling to a display; and
a control element coupled to the backplane interface and the display interface, the control element being capable of snooping the bi-directional two wire bus and converting data on the bi-directional two wire bus to a readable format for display via the display interface.

2. The test assembly according to claim 1 wherein:
the bi-directional two wire bus is an inter-integrated circuit (I²C) bus and the two bus wires comprise a serial data line (SDA) and a serial clock line (SCL).

3. The test assembly according to claim 2 further comprising:
a process executable in the control element that snoops the I² C bus by monitoring for the SDA to go low and no activity on the SCL to detect a START bit, capturing a data byte, sending a hexadecimal character to the display interface for display, capturing ACK/NACK, determining a STOP bit after ACK, and looping to capture another data byte if STOP bit is determined.

4. The test assembly according to claim 1 wherein:
the control element is programmable to optimize test functionality of multiple types of blades that can be inserted into the backplane.

5. The test assembly according to claim 1 wherein:
the control element can be programmed with a downloadable program to download different test functions and optimize test functionality of multiple types of blades that can be inserted into the backplane.

6. The test assembly according to claim 1 wherein:
the control element is capable of monitoring backplane signals selected from among a group comprising address signals, clock signals, data signals, tip signals, ring signals, ground signals, enable signals, and power rails.

7. The test assembly according to claim 1 wherein:
the test assembly has mechanical and signal characteristics that are compliant with PCI Industrial Computer Manufacturers Group (PICMG™) 3.0 specification.

8. A test assembly comprising:
a printed circuit board with physical dimensions compliant with a standard for open architecture modular computing components;
a backplane interface coupled to the printed circuit board and capable of interfacing to a backplane;
at least one power converter mounted on the printed circuit board and capable of converting power from a single source to a power levels utilized on the printed circuit board; and
a test controller coupled to the printed circuit board capable of programmably and flexibly testing communication and control signals on the backplane.

9. The test assembly according to claim 8 wherein:
at least one channel coupled to the backplane comprises a bi-directional two wire bus; and
the test controller is capable of snooping the bi-directional two wire bus and converting data snooped from the two wire bus to a readable format.

10. The test assembly according to claim 8 wherein:
at least one channel coupled to the backplane comprises an inter-integrated circuit (I²C) bus with two bus wires comprising a serial data line (SDA) and a serial clock line (SCL); and the test controller is capable of snooping the I²C bus and converting data snooped from the I²C bus to a readable format.

11. The test assembly according to claim 10 further comprising:
a process executable in the test controller that snoops the I²C bus by monitoring for the SDA to go low and no activity on the SCL to detect a START bit, capturing a data byte, sending a hexadecimal character to the display interface for display, capturing ACK/NACK, determining a STOP bit after ACK, and looping to capture another data byte if STOP bit is determined.

12. The test assembly according to claim 8 wherein:
the at least one power converter is capable of converting power from a single −48V DC source to a power levels selected from among a group of power levels including a 3.3V, 50W level, a 5V, 50W level, a 12V, 50W level, and a −12V, 36W level.

13. The test assembly according to claim 8 wherein:
the test controller is capable of monitoring backplane signals selected from among a group comprising address signals, clock signals, data signals, tip signals, ring signals, ground signals, enable signals, and power rails.

14. The test assembly according to claim 8 wherein:
the test assembly has mechanical and signal characteristics that are compliant with PCI Industrial Computer Manufacturers Group (PICMG™) 3.0 specification.

15. An article of manufacture comprising:
a controller usable medium having a computable readable program code embodied therein for testing components in an open architecture modular system that includes a backplane having at least one channel that further comprises a bi-directional two wire bus, the computable readable program code further comprising:
a computable readable program code capable of causing the controller to snoop the bi-directional two wire bus; and
a computable readable program code capable of causing the controller to convert signals snooped from the bi-directional two wire bus to a readable format.

16. The article of manufacture according to claim 15 further comprising: a computable readable program code capable of causing the controller to display the readable format.

17. The article of manufacture according to claim 15 wherein: the bi-directional two wire bus is an inter-integrated circuit (I²C) bus and the two bus wires comprise a serial data line (SDA) and a serial clock line (SCL).

18. The article of manufacture according to claim 15 further comprising:
a computable readable program code capable of causing the controller to snoop the I²C bus by monitoring for the SDA to go low and no activity on the SCL to detect a START bit, capturing a data byte, sending a hexadecimal character to the display interface for display, capturing ACK/NACK, determining a STOP bit after ACK, and looping to capture another data byte if STOP bit is determined.

19. The article of manufacture according to claim 15 further comprising:
a computable readable program code capable of causing the controller to download different test functions and optimize test functionality of multiple types of blades that can be inserted into the backplane.

20. The article of manufacture according to claim 15 further comprising:
a computable readable program code capable of causing the controller to monitor backplane signals selected from among a group comprising address signals, clock signals, data signals, tip signals, ring signals, ground signals, enable signals, and power rails.

21. The article of manufacture according to claim 15 wherein:
the open architecture modular system is compliant with PCI Industrial Computer Manufacturers Group (PICMG™) 3.0 specification.

22. A storage element readable by a controller tangibly embodying a program of instructions executable by the controller to perform method steps for testing components in an open architecture modular system that includes a backplane having at least one channel that further comprises a bi-directional two wire bus, the method steps comprising:
snooping the bi-directional two wire bus; and
converting signals snooped from the bi-directional two wire bus to a readable format.

23. In the storage element according to claim 22, the method steps further comprising:
displaying the readable format.

24. The storage element according to claim 22 wherein:
the bi-directional two wire bus is an inter-integrated circuit (I²C) bus and the two bus wires comprise a serial data line (SDA) and a serial clock line (SCL).

25. In the storage element according to claim 22, the method further comprising:
snooping the I²C bus by monitoring for the SDA to go low and no activity on the SCL to detect a START bit, capturing a data byte, sending a hexadecimal character to the display interface for display, capturing ACK/NACK, determining a STOP bit after ACK, and looping to capture another data byte if STOP bit is determined.

26. In the storage element according to claim 22, the method further comprising:
downloading different test functions and optimize test functionality of multiple types of blades that can be inserted into the backplane.

27. In the storage element according to claim 22, the method further comprising:
monitoring backplane signals selected from among a group comprising address signals, clock signals, data signals, tip signals, ring signals, ground signals, enable signals, and power rails.

28. The storage element according to claim 22 wherein:
the open architecture modular system is compliant with PCI Industrial Computer Manufacturers Group (PICMG™) 3.0 specification.
